(19) United States
(12) Patent Application Publication
(10) Pub. No.: US 2005/0280813 A1
(43) Pub. Date: Dec. 22, 2005

(54) Infrared spectroscopy as an assist for cytological investigation

(76) Inventors: Howland D. T. Jones, Edgewood, NM (US); Mark R. Robinson, Albuquerque, NM (US); Robert D. Johnson, Albuquerque, NM (US); Cliona M. Fleming, County Kildare (IE); Christepher D. Brown, Albuquerque, NM (US)

Correspondence Address: V. Gerald Grafe, esq.;General Counsel, InLight Solutions, Inc., 800 Bradbury SE, Albuquerque, NM, 87106, US

(21) Appl. No.: 11/153,596

(22) Filed: Jun. 15, 2005

Related U.S. Application Data
(60) Provisional application No. 60/580,077, filed on Jun. 16, 2004.

(51) Int. Cl. G01J 3/00

(52) U.S. Cl. 356/300

(57) ABSTRACT

The present invention provides a method for using infrared light either alone or in conjunction with visible light to create an improved system for cytologic examination. As stated above, infrared light is sensitive to molecular and biochemical changes and can thus be used to identify specific chemical species or substances. This characteristic can be used to identify areas on a slide most likely to contain an abnormality, and can further provide information to overlay on an image of the slide to enhance the visual contrast for the human screener. This process of image enhancement via the use of multivariate spectroscopy can be used to dramatically enhance the information content provided to the medical professional.

### CROSSREFERENCE TO RELATED APPLICATIONS

This application claims the benefit of U.S. provisional application 60/580,077, “Infrared Spectroscopy as an Assist for Cytological Investigation,” filed Jun. 16, 2004, incorporated herein by reference.

### FIELD OF THE INVENTION

The present invention generally relates to the screening of cytology samples, and more specifically to the use of spectroscopy to assist in the detection of morphological abnormalities contained within these cytology samples.

### BACKGROUND OF THE INVENTION

Worldwide, cervical cancer is the second-most commonly occurring cancer among women, with a yearly incidence of 471,000. Nearly half of these women will eventually die from the disease. In the United States, the incidence rank is 9, with 12,900 women diagnosed annually. One-third of these diagnosed women will die from cervical cancer. In developed nations like the United States, the main reason that cervical cancer incidence and mortality are lower than in other countries is attributed to the successful implementation of a screening program for cervical cancer.

The traditional screening program for cervical cancer has been termed Pap testing. In this test, exfoliated cervical cells are collected from the cervix during routine gynecological examination, at least once every three years. The cells and other material from the cervix are then smeared onto a glass slide, which is immediately sprayed with a fixative. The slide is transported to a laboratory where the slide is stained and covered with a glass cover slip. A cytotechnologist then examines all cells on the slide using a microscope. If all cells appear normal, the cytotechnologist deems the slide “within normal limits” and no immediate further examination is required. If abnormal cells are found (usually 8-12% of the time) the cytotechnologist marks abnormal cells, and a pathologist who makes the final diagnosis reviews the slide again. Follow-up procedures are based upon the pathologist's diagnosis, and can range from repeat Pap testing to colposcopy-directed biopsy to cryosurgery. In the United States, cytotechnologists are federally mandated to review no more than 80 slides per day. The government also requires all slides to be saved for at least five years, and that 10% of normal slides be randomly re-reviewed for quality control.

During the past decade, some alternatives to the traditional Pap test procedure have been developed. Several companies have improved the sample preparation methodology by developing liquid-based preservative media into which the collected sample is placed instead of immediately being smeared onto a slide. This process ensures that all cells on the collection instrument are transferred to the next step of the screening procedure. These same companies have developed machines to automatically plate a thin layer of cells from the liquid preservative onto a slide, which improves the readability of the slide.

Several companies have also employed imaging systems coupled with computer-based image classification algorithms to guide the cytotechnologist to the slides or portions of the slides that most likely contain abnormal cells. Kuan et al. disclose in U.S. Pat. No. 6,181,811, incorporated herein by reference, a method that automatically scans slides plated with cervical samples and identifies suspicious cells or regions of the slide based on cellular features that can include, for example, the ratio of cellular nuclear material to cellular cytoplasm. Based on the nature of the cellular features, a probability of cellular abnormality is assigned to the image field of view. The probability of sample abnormality is evaluated based on the probabilities of the individual FOVs. If the sample is considered suspicious based on a pre-determined probability threshold, the cytotechnologist is directed to those regions with highest probability of containing abnormal cells. Kuan et al. teach that it is possible to adjust the probability of abnormality thresholds to optimize the automated screening process according to various cost metrics, including the operational cost of reading the slide or the false negative rate. Zahniser et al., in PCT WO 01/33191, incorporated herein by reference, disclose a method for automatically screening cytological samples using a multi-wavelength approach. This method comprises first fixing a cytological sample on a slide and then staining the sample with stains that preferentially bind to either cytoplasmic material or cellular nuclear material, or both. The stained sample is then positioned in an imaging system, which acquires multi-wavelength high-resolution images of the stained sample using, for example, multiple LEDs as the illumination source. The different stains attenuate the different wavelengths preferentially, and therefore the image intensity will vary with the density of the stained cellular material in a wavelength-dependent manner. The system analyzes the sample images to determine, for example, the integrated ratio of cellular nuclear material to cellular cytosplamic material, and characterizes the likelihood that regions of the slide contain abnormal cells based on this ratio. Slides deemed suspicious of containing abnormal cells are selected for further review by a technician or pathologist, who is directed to the suspicious region or regions of the slide based on the multi-wavelength image analysis. Computer-assisted methods, such as the two aforementioned examples, ultimately key on morphological features in the cell to distinguish normal from abnormal cells.

Despite its success in lowering the incidence and mortality of cervical cancer, Pap testing is not ideal. A recent meta-analysis conducted by the Agency for Health Care Policy and Research concluded that traditional Pap testing has a sensitivity of 0.51 and specificity of 0.98. Thus, 51% of all abnormal smears are missed by the screening test, and 26% of all follow-up procedures on abnormal test results are unnecessary (for a disease prevalence of 10%). The same report stated that thin-layer, liquid-based preparations reduced the false negative rate by 60%, resulting in a sensitivity of 0.80. However, specificity for the new preparation method was unable to be elucidated from existing data.

Infrared spectroscopy is a well-known analytical technique for assessing both the qualitative and quantitative character of samples. Energy in the infrared region of the electromagnetic spectrum corresponds to vibrations at the molecular level, and like any vibrating body, the frequency of the vibration depends on the structural characteristics of the body. For molecules, the structure is defined by the interconnectivity of atoms through bonds of varying strengths. The myriad possibilities for atomic connectivity in different bonding environments leads to an astonishing variety of potential vibrational frequencies, and as a crude approximation for a molecule with N atoms the approximate number of different vibrational frequencies is 3*N-6 (ignoring selection rules). This information is so structurally selective that it is used by chemists to determine the structure of unknown molecules from the infrared spectrum. The other advantage afforded by infrared spectroscopy is the quantitative relation known as Beer's Law (or the Beer-Lambert Law), which states that the absorbance of infrared energy is in direct linear proportion to the concentration of the molecules in the sample. Therefore, if the concentration of a molecular species doubles, the intensity of the infrared absorbance will also double. Infrared spectroscopy is certainly not the only analytical method capable of determining the constitution of biological samples, however it can be operated in a mode that requires little to no sample preparation and is completely non-destructive, which greatly differentiates it from methods such as mass spectroscopy, or nuclear magnetic resonance spectroscopy.

Applications of infrared spectroscopy in the biological domain abound, such as the analysis of protein primary and secondary structure—the amide I bands in the IR spectra of proteins between 1600 and 1700 cm⁻¹ (predominantly C═O stretching vibrations) are well-established indicators of the polypeptide backbone geometry—and composition of cells and tissues. C. R. Middaugh, H. Mach, J. A. Ryan, G. Sanyal, D. B. Volkin, Infrared Spectrosopy, in Methods in Molecular Biology Volume 40: Protein Stability and Folding: Theory and Practice, B. A. Shirley Ed., Humana Press, Totowa, N.J. (1995); E. A. Cooper, K. Knutson, FTIR Spectroscopy Investigations of Protein Structure, in Physical Methods to Characterize Pharmaceutical Proteins, J. N. Herron et al. Eds., Plenum Press, New York, N.Y. (1995); Krimm, S.; Bandekar, J. AdV. Protein Chem. 1986, 38, 181-364. M. Diem, S. Boydston-White, L. Chiriboga, “Infrared Spectroscopy of Cells and Tissues: shining light onto a novel subject”, Applied Spectroscopy 1999, 53: 148A-161A. The potential of IR spectroscopy to identify cancerous cells and tissues was first demonstrated in the early 1990's. Wong et al., Phosphodiester stretching bands in the infrared spectra of human tissues and cultured cells, Appl. Spectrosc., 45:1563-1567 (1991); Wong et al., IR spectroscopy of exfoliated human cervical cells: evidence of extensive structural changes during carcinogenesis, Proc. Natl. Acad. Sci., 88:10988-10992 (1991). Subsequent research confirmed that spectral changes in the IR are associated with morphologically abnormal samples, with one group stating that, “analysis showed a continuum of changes paralleling the transition from normalcy to malignancy”. Specifically, it has been reported that morphologically atypical cells exhibit increased hydrogen bonding of phosphodiester groups of nucleic acids (DNA and RNA), and that reduced cell glycogen content is frequently observed in malignant specimens. In studies that included samples with a range of abnormalities, it was noted that a majority of HSIL (or CIN III) samples could be determined spectroscopically, while lower grade lesions (LSIL, or CIN I) were more difficult to consistently identify due to the fact that cellular changes are less extreme in early dysplasia.

Wong in U.S. Pat. No. 5,539,207, incorporated herein by reference, discloses a method of identifying tissue comprising the steps of determining the infrared spectrum of an entire tissue sample over a range of frequencies in at least one frequency band, and comparing the infrared spectrum of the sample with a library of stored infrared spectra of known infrared tissue types by visual comparison or using pattern recognition techniques to find the closest match. Thus, the infrared spectrum is compared with the library of stored data and from this comparison positive identification is made which can be applied to the detection of the tissue types and malignancies.

Cytological analysis has been discussed in a variety of settings. Examples, each of which are incorporated herein by reference, include:
C. R. Middaugh, H. Mach, J. A. Ryan, G. Sanyal, D. B. Volkin, Infrared Spectrosopy, in Methods in Molecular Biology Volume 40: Protein Stability and Folding: Theory and Practice, B. A. Shirley Ed., Humana Press, Totowa, N.J. (1995);
E. A. Cooper, K. Knutson, FTIR Spectroscopy Investigations of Protein Structure, in Physical Methods to Characterize Pharmaceutical Proteins, J. N. Herron et al. Eds., Plenum Press, New York, N.Y. (1995);
Krimm, S.; Bandekar, J. AdV. Protein Chem. 1986, 38, 181-364;
M. Diem, S. Boydston-White, L. Chiriboga, “Infrared Spectroscopy of Cells and Tissues: shining light onto a novel subject”, Applied Spectroscopy 1999, 53: 148A-161A;
Wong et al., Phosphodiester stretching bands in the infrared spectra of human tissues and cultured cells, Appl. Spectrosc., 45:1563-1567 (1991);
Wong et al., IR spectroscopy of exfoliated human cervical cells: evidence of extensive structural changes during carcinogenesis, Proc. Natl. Acad. Sci., 88:10988-10992 (1991);
Cohenford et al., Cytologically normal cells from neoplastic cervical samples display extensive structural abnormalities on IR spectroscopy: Implications for tumor biology, Proc. Natl. Acad. Sci. USA 95:15327-15332 (1998);
Fung Kee Fung et al., Comparison of FTIR spectroscopic screening of exfoliated cervical cells with standard Papanicolauo screening, Gynecol. Oncol., 66:10-15 (1997);
Neviliappan et al., Infrared spectral features of exfoliated cervical cells, cervical adenocarcinoma tissue, and an adenocarcinoma cell line, Gynecol. Oncol., 85:170-174 (2002) Yazdi et al., Detecting structural changes at the molecular level with FTIR spectroscopy, Acta Cytolog., 40:664-668 (1996);
Morris et al., FTIR spectroscopy of dysplastic, papillomavirus positive cervicovaginal lavage specimens, Gynecol. Oncol., 56:245-249;
Cervical cytology practice guidelines. American Society of Cytopathology. Acta Cytol March-April 2001;45(2):201-26;
D L Rosenthal, “Automation and the endangered future of the Pap test” JOURNAL OF THE NATIONAL CANCER INSTITUTE; May 20, 1998; v. 90, no. 10, p. 738-749;
Schulte, E. K. W. & Wittekind, D. H., “Standardization of the staining process as a prerequisite for successful quantitative microscopy and automated cytology screening”, in Automated Cervical Cancer Screening, eds Grohs, H. K., Husain, O. A. N. Igaku-Shoin Medical Publishers Inc, New York (1994);
Chapter 15, Husain O. A. N. “The Staining Process: Automation and Cross-contamination problems”, in Automated Cervical Cancer Screening, eds Grohs, H. K., Husain, O. A. N. Igaku-Shoin Medical Publishers Inc, New York (1994);
R. O. Duda, P. E. Hart, D. G. Stork, Pattern Classification, 2^{nd} Ed., J. Wiley & Sons, New York (2001);
G. J. McLachlan, Discriminant Analysis and Statistical Pattern Recognition, J. Wiley & Sons, New York (1992).

Haaland et al. in U.S. Pat. No. 5,596,992, incorporated herein by reference, disclose a multivariate classification technique applied to spectra from cell and tissue samples irradiated with infrared radiation to determine if the samples are normal or abnormal. Mid- and near-infrared radiation are disclosed as being used for in vitro and in vivo classifications using at least 3 different wavelengths. Haaland et al. teach that some normal/abnormal differences in cell and tissue samples are so subtle as to be undetectable using univariate analysis methods, but that accurate classification can be made using infrared spectroscopy and a multivariate calibration and classification method such as partial least squares, principal component regression, or linear discriminant analysis, comparing the spectrum of a sample with those from other samples.

Cohenford et al. in U.S. Pat. No. 6,146,897, incorporated herein by reference, disclose a method to identify cellular abnormalities that are associated with disease states. The method utilizes infrared spectra of cell samples that are dried on an infrared transparent matrix and scanned at the frequency range 3000-950 cm⁻¹. The identification of samples is based on establishing a reference using a representative set of spectra of normal and/or diseased specimens. During the reference assembly process, multivariate techniques are utilized, comparing the spectrum of a sample with those from other samples.

Current methods, however, have not demonstrated sufficient accuracy for many applications. Accordingly, there is a need for improved methods of classifying samples based on their optical characteristics.

Although automated, assisted screeners provide a labor savings over traditional (manual) screening, there are several recognized areas of difficulty associated with their implementation. Since the goal of existing image recognition systems is to detect abnormalities in a similar fashion to human cytologists, slides must be stained prior to analysis (as they are for human viewing). Furthermore, the same slides must be suitable for evaluation by both the automated and human screener, since every sample identified as abnormal by the automated system must subsequently be examined by a human. Consequently, the stain used must be suitable for both human screeners (cytologists and pathologists) and the automated system.

Currently, the modified Papanicolaou method is recommended for the staining of gynecologic cytology slides. The Papanicolaou method uses a standard nuclear stain, hematoxylin, and two cytoplasmic counterstains, OG-6 and EA, which results in a cellular sample that not only has well-defined and tinted morphologic features, but also has transparency to allow for microscopic visualization of nuclear and cytoplasmic boundaries through multiple layers of epithelial cells. However, this stain cannot be used for quantitative staining, since the nuclear hematoxylin content does not correlate with the nuclear DNA content; moreover, hematoxylin also stains RNA and negatively charged proteins. Various substitutes for the Pap stain have been recommended, most of which involve an alternate nuclear stain, but the modified version of the traditional Pap stain persists as the recommended staining procedure.

Although the experienced human eye can be forgiving, the performance of an imaging system is considerably compromised if the slide quality is not optimal. With the AutoPap 300 system, for example, slides had to be normalized for stain and fixation qualities to ensure robust classification and highest signal to noise ratio.

Another possible error source is cross-contamination from the staining process alone. Automated stainers have been shown to dislodge cells from Pap samples and redeposit these dislodged cells onto other Pap samples, thereby increasing the possibility of false positives. Several attempts have been made to improve the staining process with the goal of reducing cross-contamination issue, but it remains an issue. The possibility of a solution-free computerized “stain” based upon the biochemical makeup of the cell would be ideal and prevent any cross-contamination.

In contrast, the IR measurement described herein does not require staining to identify the abnormal cells, since the basis for screening is not dependent on morphology and the traditional cytological approach. The IR measurement can determine locations of the abnormalities on an unstained slide using their inherent biochemical signal, after which the slide may be stained using the typical Pap staining protocol for further human assessment. As such, this technique is not limited by variations in stain intensity or by the possibility of detecting abnormalities resulting from cross-contamination during the staining procedure.

### SUMMARY OF THE INVENTION

The present invention provides a method for using infrared light either alone or in conjunction with visible light to create an improved system for cytologic examination. As stated above, infrared light is sensitive to molecular and biochemical changes and can thus be used to identify specific chemical species or substances. This characteristic can be used to identify areas on a slide most likely to contain an abnormality, and can further provide information to overlay on an image of the slide to enhance the visual contrast for the human screener. This process of image enhancement via the use of multivariate spectroscopy can be used to dramatically enhance the information content provided to the medical professional.

### BRIEF DESCRIPTION OF THE DRAWINGS

The drawings, which are not necessarily to scale, depict illustrative embodiments and are not intended to limit the scope of the invention.

FIG. 1 is a system diagram of an imaging spectrometer according to the present invention.

FIG. 2 depicts schematic representations of image of a sample of interest

### DETAILED DESCRIPTION OF THE INVENTION

### EXAMPLE INSTRUMENT

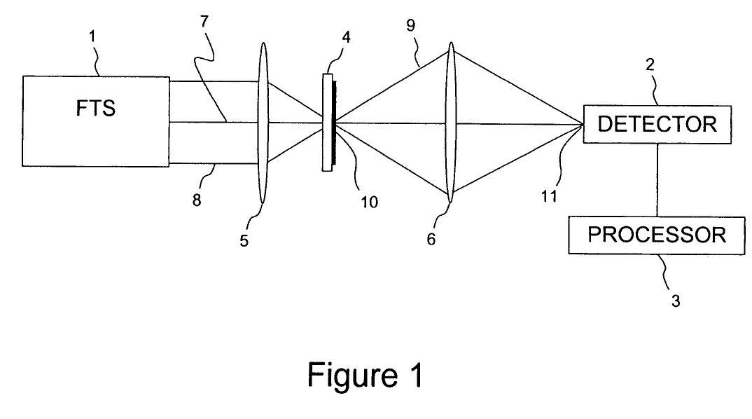

FIG. 1 is a system diagram of an imaging spectrometer according to the present invention. The Fourier transform spectrometer (FTS) 1 produces a spectrally-multiplexed input beam 8 of broadband infrared radiation. The center of the input beam 8 defines an optical axis 7. Focusing optics 5 (shown schematically as a lens) collect the input beam 8 and focus it at a sample of interest 10, which can be mounted on a substrate 4. Radiation 9 passing through the sample of interest 10 is collected by collecting and imaging optics 6 (shown schematically as a lens) and is imaged 11 onto a detector 2. The detector 2 measures the intensity of the incident radiation and is interfaced to the processor 3. The processor 3 contains a microprocessor, memory, data preprocessing algorithms, the multivariate calibration model and algorithm and outlier detection algorithms.

The specific embodiments are based on a FTS using a Michelson interferometer as a wavelength-selective element. Other embodiments based on a dispersive spectrometer can use a grating or a prism as the wavelength-selective element. Those skilled in the art appreciate that other types of wavelength-selective elements can be substituted without departing from the scope of the present invention.

The sample of interest 10 can be mounted on a substrate 4 or supported by other means. For example, biological specimens such as human cervical cells can be mounted on to a suitable substrate, as in a microscope slide. Substrates can include infrared transparent materials such as Barium Fluoride, Caesium Iodide, Calcium Fluoride, Cubic Zirconium, Diamond, Irtran-2, Lithium Fluoride, Magnesium Fluoride, Potassium Bromide, Potassium Chloride, Quartz, Sapphire, Silver Bromide, Silver Chloride, Sodium Chloride, Thallium Bromide, Thallium Bromo-Iodide, Thallium Bromo-Chloride, Zinc Selenide, and Zinc Sulfide (including multi-spectral grade). The preceding is not to be considered a comprehensive list; other materials can be suitable. Those skilled in the art appreciate that other methods for supporting a sample of interest can be substituted without departing from the scope of the present invention.

The optical system is appropriately tailored to the relevant portion of the infrared spectrum. In some embodiments, the optics will be reflective optics. So, although focusing optics 5 and collecting and imaging optics 6 are shown schematically as single-element lenses, one skilled in the art will recognize that these single-element lenses could be replaced with compound lenses, single or compound mirrors, or some combination thereof, without departing from the scope of the present invention.

Additionally, the optical system, including the combination of the focusing optics 5, collecting and imaging optics 6, and detector 3, is tailored to obtain the desired spectral imaging characteristics for the sample of interest 10. The desired field of view, throughput, beam uniformity, spectral region, spatial resolution and image magnification, and sampling method can be used to determine the appropriate design of the optical system. For example, consideration of a variable magnification optical system, or zoom lens, can be employed as part of the imaging optics 6 in order to change the magnification and/or field of view of the sample of interest 10 as seen by the detector 3.

In one embodiment of the present invention, a mercury cadmium telluride (MCT) detector is used, providing spectral response from 2 μm to 11 μm wavelength. In another embodiment, an indium antimonide (InSb) detector is used. Those skilled in the art appreciate that other types of detectors may be substituted according to the spectral region of interest desired without departing from the scope of the present invention.

The processor manipulates the collected spectral signal into a form that is compatible with the application of various data transformation algorithms, multivariate calibration models, and classification algorithms. The processor is further used to apply said algorithms and models. Furthermore, the processor is used to transform the derived infrared signal that distinguishes normal cells or groups of cells from abnormal cells or groups of cells based on the molecular or biochemical information into a form that can be used to visually enhance an image of the cytological specimen.

An example embodiment is based on a single-pass transmission sampling method, as depicted in FIG. 1. Those skilled in the art appreciate that other types of sampling methods can be used without departing from the scope of the present invention. For example, one method can include a sample of interest supported on a substrate that is substantially reflective in the infrared, such as a low emissivity (low-e) slide, where infrared radiation incident on the sample is reflected off the reflective slide and subsequently imaged onto the detector. See, for an example of such a slide, U.S. Pat. No. 6,274,871. In another embodiment, attenuated total reflection (ATR) is used to allow for evanescent coupling of infrared radiation with a sample of interest, and subsequent imaging onto the detector. See, for an example of such a system, U.S. Pat. No. 6,141,100.

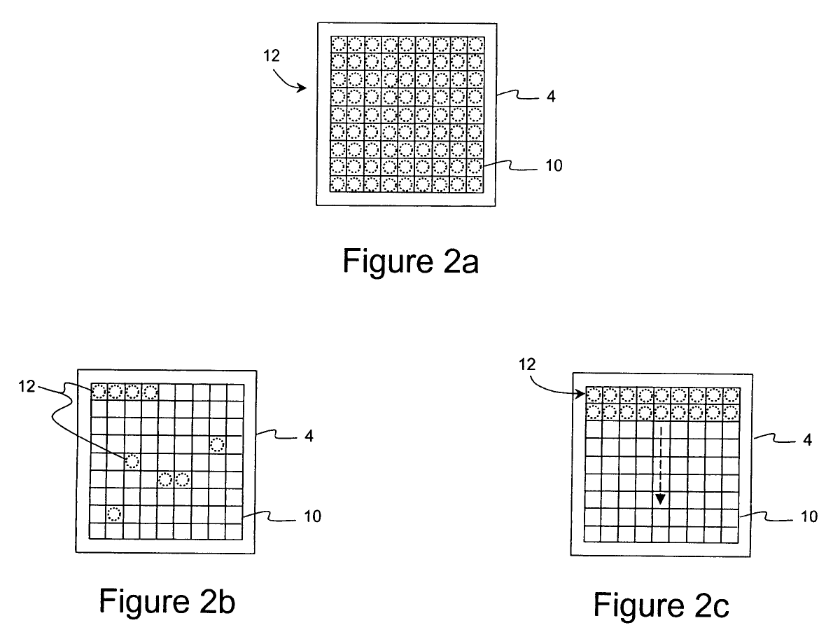

The previous discussion describes general instrument details of an imaging spectrometer in accordance with the present invention. Consistent with that, various methods can be employed to obtain spatially resolved spectral information of a sample of interest. FIGS. 2a-c depict characteristic of various embodiments, whose methods may include focal plane array imaging, point-by-point mapping, and horizontal scanning of a linear array.

FIG. 2a is a schematic representation of an image of a sample of interest 10, whereby an imaging scheme employing a focal plane array detector is used to achieve spatially resolved spectral information. In this embodiment, an image 12 of the sample of interest 10 supported on a substrate 4 is formed onto a focal plane array detector, depicted here for illustrative purposes as a 9×9 array of discrete detector elements, or pixels. While the figure shows a 9×9 array, one skilled in the art will appreciate that any combination of horizontal and vertical pixels can be used. For example, state-of-the-art commercially available infrared focal plane arrays have formats such as 64×64 pixels, 128×128 pixels, and 320×256 pixels, among others.

The format of the focal plane array detector, coupled with the imaging optics, determines the field of view and spatially resolved extent of spectral information that can be obtained from a sample of interest. For example, using a 1:1 imaging system (unit magnification) with a 64×64 pixel focal plane array detector, and each pixel having physical dimensions of 60 μm×60 μm, an area of the sample of interest of approximately 3.8 mm×3.8 mm can be imaged at a spatial resolution of 60 μm×60 μm; intensity information of the corresponding discrete areas of a sample of interest can be obtained at each pixel.

Dependent upon the focal plane array detector format and imaging optics, the entire sample of interest, or a portion of it, can be imaged at once. If imaging portions of the sample, provisions can be included for one- or two-dimensional lateral translation of the sample of interest 10 in a plane perpendicular to the optical axis 7. In this manner the entire sample can be imaged spectroscopically. Alternatively, methods to scan the beam across the sample of interest or translate the detector to build up an image of the entire sample can be suitable.

FIG. 2b is a schematic representation of an image of a sample of interest, whereby an imaging scheme employing point-by-point mapping is used to achieve spatially resolved spectral information. In this scheme, an image 12 of a small portion of the sample of interest 10 is formed onto a single detector element. Once the desired intensity information for that portion of the sample is obtained, the sample is translated in a plane perpendicular to the optical axis 7 such than a new portion of the sample is imaged onto the detector. In this manner, an entire spectral image of the sample, or of selected portions of the sample, can be built up point-by-point. Additionally, methods to scan the beam across the sample of interest or translate the detector to build up an image of the entire sample can be suitable.

FIG. 2c is a schematic representation of an image of a sample of interest, whereby an imaging scheme employing a horizontal scan pattern is used to achieve spatially resolved spectral information. In this example, an image 12 of a linear section of the sample of interest 10 is formed onto a linear array detector. Once the desired intensity information for that section of the sample is obtained, the sample is translated in a plane perpendicular to the optical axis 7 such than a new linear section of the sample is imaged onto the detector. In this manner, an entire spectral image of the sample is built up point-by-point. Additionally, methods to scan the beam across the sample of interest or translate the detector to build up and image of the entire sample can be suitable.

### EXAMPLE ANALYSIS

The identification of atypical cellular features proceeds through distinct notional steps, although enhanced numerical efficiency can be gained by mathematically combining several operations where possible. With the spectroscopic data collected, an initial compression step can reduce the spectroscopic variables such as wavelength channels into smaller classes of variables that are known to be related to the important chemical and morphological features of cells. Such compression steps can employ wavelet transform methods, or projections onto reduced basis sets previously identified as informative, e.g., basis sets characterizing the dominant directions of variance in other experimentally observed data sets. Normalization procedures can be used in conjunction with compression steps to enhance contrast in particular discriminatory features, e.g., normalization to indicators of glycogen concentration, or the amide I/II absorption. With the spectroscopic information represented in a compressed set of variables, supervised, or unsupervised classification methods, or a combination thereof, can be used.

A supervised classification method uses the knowledge gained from observing examples of specimens with normal and abnormally associated spectra to classify other acquired measurements with unknown association. The method is goes through a training phase using observations from samples with known classification, over which the chosen method (such as discriminant analysis, or neural networks) finds a function or set of functions which provide good classification performance according to the user's chosen measure of goodness e.g., % correctly classified. The judgment of the supervised method for a sample in question can be expressed in a variety of ways, although probabilities or likelihoods of class memberships are arguably the most common. Numerous variants on this overarching explanation are useful for classifying cervical cytology.

In one embodiment of assisted screening using IR spectroscopy, a set of cervical slides is measured on the IR instrument in order to build a classification model. A subset of those samples is normal (WNL) and the remaining samples are abnormal. The abnormal samples may comprise any one of ASCUS, LSIL, HSIL, carcinoma in situ samples, or a combination of any or all of the above. The slides are subsequently stained and evaluated by a cytologist or pathologist or by multiple cytologists/pathologists in order to determine class assignments for the classification model spectra. A supervised two-class model can be built from one set of spectra that are assigned to the normal class and a second set of spectra assigned to the abnormal class. In a first embodiment, class assignments are based on morphology at the cellular level, where each cell and corresponding spectrum are assigned to a class. For example, within an ‘abnormal’ cervical sample, some cells are morphologically normal and some are morphologically abnormal. For this embodiment, the morphologically normal cells within the ‘abnormal’ cervical sample will be assigned to the ‘normal’ class for model building purposes. In a second embodiment, all cells within an abnormal sample are assigned to the same class as that sample. In such a case, abnormal spectra can be from cells that are morphologically abnormal or morphologically normal, and the basis of the class assignment is the ‘field effect’ in the IR spectra (where all the cells in a sample exhibit spectroscopic features characteristic of abnormality, even if only some of the cells are morphologically abnormal).

Once class assignments have been made, spectral processing, or feature selection, can enhance the discriminating features between normal and abnormal spectra. In one embodiment, the wavenumber region is reduced to those wavenumbers between 900 and 3700 cm⁻¹, with wavenumbers 1800 to 2700 cm⁻¹ excluded. In a second embodiment, all spectral intensities within a spectrum are normalized to the intensity or the area of the amide I peak, directly associated with cellular material, in order to normalize for pathlength traveled by light through the cells on a slide. In a third embodiment, the standard deviation of spectra or multivariate signals representative of cell content is computed across multiple cells on a slide in order to provide a feature set that represents the additional variation in a data set that comprises cells at differing stages of abnormality. This information can identify regions of the slide with highly variable spectral features, indicating increased cellular variation in those regions and identifying those regions as suspicious for containing abnormal cells. It is recognized by those skilled in the art that other processing steps can also enhance discrimination between normal and abnormal spectra for cervical cancer.

Given a set of spectra assigned to normal and abnormal classes, the classification model is generated. In one embodiment for assisted screening, linear discriminant analysis (LDA) is used to build the model. This method maximizes the ratio of between-class variance to the within-class variance in any particular data set thereby guaranteeing maximal separability. In the case of cervical screening, LDA models the differences between normal and abnormal spectra in approximately 10 to 15 LDA factors, where the factors have been selected such that the ratio of between-class to within class variance is maximized. When applied to a set of newly acquired spectra (not in the calibration set), the output is generally a set of posterior probabilities which range from 0 to 1. These probabilities comprise one form of data output that can be displayed to the user as indicators of degree of abnormality in a cell or sample. Other classification methods can be applied in a similar manner, methods such as support vector machines, neural networks, quadratic discriminant analysis, logistic regression and mahalanobis distance classifiers.

Another embodiment that has proven successful for assisted screening with IR spectroscopy has involved bagging (or bundling) different feature processing methods in addition to combining various classification techniques. These approaches can also be viewed as ‘mixture of experts’ models. In this type of technique, multiple feature selection algorithms are applied to the data. All of these feature selection outputs are then modeled using different classification methods, and the result is a large number of model outputs, each of which, taken individually, can give a probability of abnormality for each sample in a prediction data set. In the bundling/boosting method, all of these outputs are combined in a fashion so as to improve the classification result when compared to the individual results. The method of combination might be a form of weighted averaging, a voting procedure, or a combination of these techniques. In the case that weights are applied, the weights can be determined as a function of the overall classification ability of the individual techniques taken individually.

Unsupervised classification approaches the problem quite differently. In this circumstance no external knowledge of class memberships is assumed, and the chosen method (e.g., hierarchical clustering, self-organizing maps) attempts to independently collect or group samples according to their measurement similarity, where similarity is defined by any of a host of criteria. Unsupervised classifiers can be viewed as a contrast enhancing procedure in the context of cytologic or histologic applications in spectroscopy, since the unsupervised method will indicate which measurements are similar and which are distinct. If a collection of cells exhibit particularly extreme biochemical makeup according to the infrared spectroscopic assessment, the unsupervised classifier will be inclined to distinguish these cells from others based on their biochemical extremes. Like supervised classifiers, unsupervised classifiers can render either categorical information (e.g., class 1 or 2), or quantitative information (e.g., 0.223).

In an example of the application of unsupervised classification to assisted cytologic screening, the system may determine the most extreme areas of the slide based on the infrared spectroscopic measurement. The majority of normal cells will exhibit similar infrared spectra, since the biochemical constitution of these cells will fall within a normal range. Cells with atypical biochemical constitution or structure will be extreme in terms of their infrared spectra. Therefore, biochemical constitution or structure will be extreme in terms of their infrared spectra. Therefore, a processing method that identifies the extreme biochemical signatures is useful for directing the analyst immediately to the most suspicious or anomalous cellular phenomena, thereby reducing the amount of time examining non-distinct cells. For example, independent component analysis can be applied to the acquired spectral data (or alternatively projection pursuit, or principal components analysis) to identify spectral indicators associated with large differential entropy. The locations on the slide most exemplary on these identified indicators can be preferentially examined by the cytotechnologists.

In another embodiment the system can stratify cells into two or more categories based on their infrared spectrum. Since the analyst is assured that cells from each category are similar in biochemical constitution, they would only have to examine examples from each category, eliminating the requirement to examine many regions of the slide. Self-organizing maps and clustering methods can be used to generate such partitions in the spectral data. Regions on the slide exemplifying these clusters of infrared similarity can be preferentially examined by the cytotechnologists for assessment.

In another embodiment, an analyst can use knowledge of cervical cytology to register a small number of morphologically normal cells on a slide. Based on a comparison of other infrared spectra on the slide to the spectra of the registered morphological normals, the system can guide the analyst to those cells most distinct from the registered normals. Measures of similarity can include the elementary Minkowsky distances (e.g., Euclidean and Manhattan distance), or more targeted measures such as Mahalinobis distance. The converse can also be useful. The analyst can electronically register some cells as atypical, and have the system identify other cells across the entire specimen biochemically consistent with those registered. Those cells most biochemically distinct from the registered cells are prioritized for examination by the analyst.

In some situations a hybrid of supervised and unsupervised methods can be employed. For example, a supervised classifier can be designed to distinguish between debris and cells based on their infrared signature. An unsupervised classifier as described above can be precluded from indicating debris as an extreme region on the slide, if the supervised classifier has designated the region as characteristic of debris.

All of the embodiments noted above can enhance the sensitivity of the analyst and system in general by greatly reducing the number of nondescript cells under evaluation.

It is important to note that although the language above refers to the infrared spectrum or spectra, it is often valuable to apply these classification methods to transforms such as Fourier transforms (FT) of the individual spectra. In some instrumental platforms, such as Fourier transform spectrometers, the raw data is acquired as an interferogram, and FT'd to generate the spectrum. Since the FT is a mathematical operation requiring significant computational resources, it is advantageous if such supervised and unsupervised classifiers can be applied directly in the Fourier, or interferometric domain. This applies equally to Hadamard transform (or similar) spectrometers. An example of this is the use of the interferograms to isolate areas of significant cell density on the slide. A coarse field image can be rapidly acquired, and inferograms analyzed for cellular characteristics. A higher resolution or higher signal to noise image can then be acquired only for the regions showing considerable cellular presence or diversity, a significant time savings in real-time applications.

In conjunction with the above, the system can be used to information-enhance the visual image provided to the cytotechnologist. When examining either a stained or unstained sample with the unaided eye a portion of the visual information content provided contains no useful information concerning the presence of an abnormality. Additionally the information is limited to the wavelengths of light that the eye can detect. In the present invention no such limitation exists. The system can record specific wavelength bands, or can measure a broad spectrum of light. The system can combine spectroscopic information from many spectral regions and modalities. Since the system can detect light outside the visible light spectrum, the use of spectroscopy allows the system to measure features of objects that are only present in the infrared regions, and are thus not observable in the visible region. The system can simultaneously or subsequently present this information to the medical professional via information-enhancement of the image.

Information-enhancement is the process of determining the more relevant information for making a diagnosis and then presenting the information in the most effective manner for the analyst to review. Determining the most relevant information to present can be achieved through empirical testing or through the use of references like the Fung Kee Fung paper. The system can process the spectra such that the irrelevant spectroscopic information or noise is filtered out and only the light relevant to a specific molecular species is maintained. It is important to note that key molecular signatures can be caused by absorbances at multiple wavelengths and by several chemicals in combination. This process of using spectroscopy to quantify molecular substances can be thought of broadly as a spectroscopic staining technique. Conventional stains are often developed for a particular molecular or cellular component. For example, many stains have been designed to enhance the cellular nucleus. Spectroscopy can be used in a similar manner except that the range of possible stains is virtually unlimited, the specificity of the spectroscopic stain can be very high, and the process does not alter the sample.

For illustration purposes consider the examination of a cytological sample where three molecular signatures (represented in this example as species A, B and C) have previously been identified as indicative of cellular abnormality. Assume that compound A has a visible signature, whereas compounds B and C have spectroscopic signatures in the infrared region. By using broadband spectroscopy, one can effectively filter the spectra and determine a quantitative measure of these various compounds. By quantifying, one can map the corresponding values to colors visible to the eye; for example compound A can be assigned blue, compound B assigned red, and compound C assigned green. In this manner the vast information content of the electromagnetic spectrum can be mapped down to three key parameters and then presented in a manner that makes most effective use of the dynamic range of the analyst's eye.

It is important to note that the resolution requirements of the visible image and the infrared image do not need to match. The visible image can be used to define the boundaries of the cells and other general density parameters while the infrared, likely at lower resolution, can be used to information enhance the image with color.

Those skilled in the art will recognize that the present invention can be manifested in a variety of forms other than the specific embodiments described and contemplated herein. Accordingly, departures in form and detail can be made without departing from the scope and spirit of the present invention as described in the appended claims.

1. An apparatus for presenting a sample to a user for analysis, comprising:
a. a spectroscopic subsystem, determining a spectroscopic characteristic of the sample;
b. an analysis subsystem, determining a property of the sample from the spectroscopic characteristic;
c. a presentation subsystem, presenting to a user the sample with an indication of the property.

2. An apparatus according to claim 1, wherein the analysis subsystem determines a property as a function of location on the sample, and wherein the presentation subsystem presents a representation of the sample, where a characteristic of the representation is a function of the property.

3. An apparatus according to claim 2, wherein the characteristic of the representation comprises color.

4. A method of presenting a sample, comprising:
a. Determining a spectroscopic property of the sample as a function of location;
b. Presenting a representation of the sample to a user, where a characteristic of the representation is a function of the property.

5. A method as in claim 4, wherein the characteristic of the representation comprises color.

6. A method of presenting a representation of a cervical sample to a user, comprising:
a. Plating a sample of cervical cells onto a slide;
b. Determining a response of the cells to infrared energy as a function of location on the slide;
c. Classifying the response to infrared energy as a function of location according to the desirability for further review of the cells at each location;
d. Presenting to the user a visible image of the cells on the slide with a visual indication of the desirability of further review associated with at least some locations on the slide.
